(19) United States
(12) Patent Application Publication
(10) Pub. No.: US 2009/0165328 A1
(43) Pub. Date: Jul. 2, 2009

(54) Dryer, set up for operation drawing of electric power, and method for operating it

(75) Inventors: Klaus Grunert, Berlin (DE); Uwe-Jens Krausch, Brieselang (DE); Guenter Steffens, Dallgow-Doeberitz (DE); Andreas Stolze, Falkensee (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgeraete GmbH, Muenchen (DE)

(21) Appl. No.: 12/316,459

(22) Filed: Dec. 12, 2008

(30) Foreign Application Priority Data
Dec. 27, 2007 (DE) 10 2007 062 776.0

(51) Int. Cl. F26B 3/02; F26B 25/06

(52) U.S. Cl. 34/443; 34/218

(57) ABSTRACT

The invention relates to a dryer having a drying chamber, a process air channel in which is located a heater for heating the process air and wherein the heated process air can be ducted into the drying chamber by means of a blower, a motor and a controller, which dryer is set up for operation drawing an electric power that never exceeds a pre-specified value Pₘₐₓ. Means are provided that are set up in such a way that the dryer will while operating draw the electric power at least in phases in accordance with the pre-specified value Pₘₐₓ. The invention relates also to a method for operating a dryer of such kind.

### BACKGROUND OF THE INVENTION

The invention relates to a dryer having a drying chamber, a process air channel in which is located a heater for heating the process air and wherein the heated process air can be ducted into the drying chamber by means of a blower, a motor and a controller, which dryer is set up for operation drawing an electric power that never exceeds a pre-specified value Pₘₐₓ, and to a method for operating a dryer of such kind.

The dryer is known in the form of a domestic appliance, namely a dryer for drying damp laundry such as accrues in a private household, or a dishwasher for washing and drying crockery in a private household.

A laundry dryer is generally operated as a vented or circulating-air dryer. In either case air (what is termed process air) is ducted by means of a blower via a heater into a drum that contains damp items of laundry and serves as a drying chamber. The hot air absorbs moisture from the items of laundry being dried. In vented dryers the process air laden with moisture after passing through the drum is generally ducted out of the dryer and the building in which it is installed through a vent hose, with no heat recovery taking place. In a circulating-air dryer, by contrast, the process air is circulated and cyclically heated, ducted for the purpose of absorbing moisture through the laundry being dried, and cooled for the purpose of condensing out the absorbed moisture. Circulating-air dryers are therefore as a rule embodied as condensation dryers.

A condensation dryer, whose mode of operation is based on condensing the moisture from the laundry evaporated by means of warm process air, does not require a vent hose and enables energy to be recovered from the heated process air, for example through the use of a heat pump. Condensation dryers are very popular because they can be used in bathrooms or laundry rooms sited in the interior of large dwelling complexes.

A vented dryer having heat recovery is known from DE 30 00 865 A1. In this vented dryer having heat recovery, ambient air (having a temperature of, for example, 20° C. and with 60% relative humidity; what is termed supply air) generally flows into the heat exchanger surfaces of an air-to-air heat exchanger and there is heated accompanied by cooling of the warm process air exiting the drying chamber. The already somewhat heated air is rerouted to the heater and then to the drum. Depending on the heat removal capacity or, as the case may be, exchange of heat, condensation water arises that is collected in a container (condensate tray) or pumped away.

Loss of energy can be significantly further reduced by employing a heat pump. In a condensation dryer fitted with a heat pump of the known compressor type, the warm, moisture-laden process air is cooled essentially in the evaporator of the heat pump, where the transferred heat is used for evaporating a cryogen employed in the heat pump circuit. The heat pump's cryogen evaporated by heating is ducted via a compressor to the heat pump's condenser, where condensing of the gaseous cryogen causes heat to be released that is used for heating the process air before it enters the drum. A vented dryer of such kind is implicitly disclosed in a short extract, available in the “Patent Abstracts of Japan” database, relating to the patent publication JP 2004 089415 A.

A customarily employed heat pump is the compressor-type heat pump that as a rule operates optimally within a precise temperature range specified in its design. What is problematic when said compressor-heat pump is used in the condensation dryer are the usually high temperatures in the condenser which for process-related reasons result in the compressor's having to be shut off and/or in a deterioration in the heat pump's efficiency. This problem is exacerbated if the compressor is supported by a supplementary heater in the process air circuit for achieving faster heating of the process air and hence shorter drying times. Controlling of a heat-pump circuit (for example by lowering the temperature of the cryogen) is therefore complex.

The air-to-air heat exchanger—operated in crossover or counter-current mode—customarily employed in a condensation dryer not having a heat pump and the electric heater are generally completely replaced by a heat pump. A twenty-to-fifty percent saving in energy can be achieved thereby. Highly energy-saving drying is possible in the case of a dryer of that type. It is not, though, generally possible to realize fast drying thereby. A very powerful and therefore expensive compressor would in particular be needed therefor.

There are, moreover, dryers in which a heat pump having a small compressor or, as the case may be, small cooling circuit is used. The absence of heat from a heater or, as the case may be, of condensation heat is therein compensated by an electric resistance heater and/or an air-to-air heat exchanger. A dryer of this type can be operated either only by means of the heat pump, by means of the heat pump and the electric resistance heater, or by means of the resistance heater and/or the air-to-air heat exchanger. It is furthermore known to employ a two-stage heater in a dryer, enabling it to be operated using permanently settable heating levels.

A vented dryer having a heat pump is in principle particularly well suited for extremely fast drying because heating power and condensing power are mutually independent therein. More heating power can be supplied without having to simultaneously increase the condensing power.

Described in DE 40 23 000 C2 is a laundry dryer that has a heat pump and in which, arranged in the process air channel between the condenser and evaporator, is an air-intake opening that can be closed by means of a controllable closing device.

Described in DE 197 38 735 C2 is a condensation dryer having a closed drying-air circuit fitted with a heat pump. The heat pump is embodied as a device operating on the absorber principle whose absorber forms a third heat exchanger through whose primary circuit a cryogen flows and via whose secondary circuit the drying air flowing out of the second heat exchanger is ducted back to the first heat exchanger's secondary circuit.

Described furthermore in DE 43 06 217 B4 is a program-controlled laundry dryer in which the process air is ducted by means of a blower in a closed process air channel in which are located closing devices arranged in a specific manner. The closing devices are appropriately actuated as a function of the operating status (heating phase, laundry drying phase, attaining of the maximum permissible temperature).

Implicitly disclosed in DE 10 2004 055 940 A1 and the parallel US 2006/0107547 A1 are a method and device for safely operating a program-controlled laundry dryer. What are in particular presented are a method for detecting faults in the drum motion and for switching the heating current for the drying air as a function of the rotary motion of the drum, and a corresponding laundry dryer. The drum's rotary motion is therein transferred through mechanical coupling to a device switching the heating current for heating the drying air, with its being possible particularly for an intermediate component to have been provided by means of which an electric signal effecting the switching action is derived from the rotary motion.

### SUMMARY OF THE INVENTION

Against this background an object of the invention is to provide a dryer that exhibits maximized drying speed and in which a heater and other consumers of electric energy can be optimally utilized in the dryer.

### DETAILED DESCRIPTION EXEMPLARY EMBODIMENTS OF THE PRESENT INVENTION

An object of the invention is thus a dryer having a drying chamber, a process air channel in which is located a heater for heating the process air and wherein the heated process air can be ducted into the drying chamber by means of a blower, a motor and a controller, which dryer is set up for operation drawing an electric power that never exceeds a pre-specified value Pₘₐₓ, the dryer having means that are set up in such a way that while operating the dryer will draw the electric power at least in phases in accordance with the pre-specified value Pₘₐₓ.

The pre-specified value Pₘₐₓ of the overall power draw P_{G} will generally depend on the implementation of the power supply grid within which the inventive dryer is operated and will have been defined by a corresponding formal or informal standard. The parts of the power supply grids—usually a.c. power grids—that are provided for powering a laundry dryer and protected frequently exhibit differences across different countries in terms of voltage, maximum value of the electric current, and frequency. The consequence thereof is that a maximum grid power P_{N}, which is approximately the product of the maximum electric current and grid voltage, can differ locally. The practice in Germany is for a fuse that will trigger if the current flowing through it exceeds a root-mean-square value of 16 amps to be provided in a building for protecting the power supply connector for a dryer. In Germany it can therefore be assumed that the maximum grid power P_{N} for a dryer is around 3600 watts.

It is preferred according to the invention for the pre-specified value Pₘₐₓ to be as close as possible to the maximum grid power P_{N}. Pₘₐₓ=P_{N} is particularly preferred.

It is also preferred for the means to include the controller. It is therein assumed that the dryer's maximum power draw is determined by the relevant design of its components, particularly of those, such as the heater, having a relatively heavy power draw and of its controller, which coordinates and controls the operation of the components.

The pre-specified value Pₘₐₓ can preferably be achieved by setting a drawn power P_{H} of the heater.

In a preferred embodiment the heater of the dryer according to the invention has at least two suitably selected switchable heating stages. The heater is preferably a two-stage heater having a first switchable heating stage in a first electric circuit and a second switchable heating stage in a second electric circuit parallel thereto.

In a particularly preferred embodiment the heater is a two-stage heater having a first heating stage in a first electric circuit and a second heating stage in a second electric circuit parallel thereto, with a thermal switch that can be appropriately switched via a signal of a thermal sensor (temperature sensor) being disposed in the first electric circuit or second electric circuit. The thermal sensor can be located in, for example, the drum, the process air channel, or the heat pump circuit.

In a preferred embodiment of the dryer according to the invention the thermal switch will switch when a pre-specified maximum value Tₘₐₓ for a temperature has been attained or exceeded and open an electric circuit in which a heating stage is located.

In said embodiment the thermal switch will preferably switch when a pre-specified minimum value Tₘᵢₙ for a temperature has been attained or undershot and close the opened electric circuit.

The first heating stage preferably has a power output less than that of the second heating stage, with, for example, the first heating stage having a power output in the 200-to-600-watt—preferably 300-to-500-watt—range and the second heating stage having a power output in the 1000-to-1800-watt—preferably 1200-to-1600-watt—range.

In an alternative embodiment the heater has means for continuously setting the heater's power output P_{H}.

The invention can be realized particularly advantageously in a dryer having a heat pump. A heat pump basically has a heat sink at which it draws heat from its surroundings and a heat source at which it supplies heat to its surroundings. The supplied heat is the sum of what is termed the pumped heat absorbed at the heat sink and the heat loss of necessity occurring while the heat pump is operating. Because only the heat loss has to be covered through the drawing of electric power by the heat pump, the heat pump's pumped heat can be utilized for supplementing the heat absorbed by the dryer as electric energy from the power supply grid to which it is connected. In total, with a dryer having a heat pump it is therefore possible to achieve a heating power that exceeds the pre-specified value Pₘₐₓ and simultaneously to keep the electric power draw limited to Pₘₐₓ. A dryer having a heat pump therefore has a potential for utilizing a particularly high heating power according with a particularly short drying time, which potential is intrinsically lacking in a dryer not having a heat pump. By particular preference the inventive dryer has a heat pump circuit having an evaporator, a condenser and a compressor.

For achieving a maximum drying speed it is likewise possible according to the invention, when a heat pump is used, to match the power P_{WP} of a heat-pump circuit in such a way that the pre-specified value Pₘₐₓ will be achieved. The matching has, though, been shown to be subject to limitations imposed by the influencing variables of the heat pump circuit (for example cryogen, compressor performance) and that setting of the electric heater (resistance heater) is advantageous.

The correlations can basically be summarized in the following equation (I),

P_{H}=Pₘₐₓ−(P_{K}+P_{S}+P_{M}+P_{aV}) (I),

where P_{H} is the heater's drawn power, Pₘₐₓ is the pre-specified value of the power, P_{K} is the compressor's power draw, P_{S} is the controller's power draw, P_{M} is the motor's power draw, and P_{aV} is the power draw of further consumers.

A further consumer of electric energy is, for example, a condensate pump that may be required in a condensation dryer for extracting condensate that forms.

The inventive dryer can be a circulating-air dryer or a vented dryer. However, it is preferred according to the invention for the dryer to be a vented dryer. A vented dryer will in principle pose no problems due to the thermal energy conveyed into the process air by a heater. A circulating-air dryer, by contrast, will require greater expenditure in terms of extracting and/or exchanging heat. That could be problematic particularly when a heat pump is used because a heat pump's cryogen works optimally within a specific temperature range owing to the chemical nature of the cryogen. The cryogen employed in the heat-pump circuit will preferably have been selected from the group comprising the cryogens R134a, R152a, R290, R407C and R410A. All the cited cryogens except for R290 are fluorinated hydrocarbons or fluorinated-hydrocarbon compounds; R290 is the hydrocarbon propane which, although relatively easily inflammable, would be very well suited as a cryogen in the present context owing to its technical properties and is, moreover, very environmentally friendly.

In a preferred embodiment the temperature of the heat pump's cryogen, especially in the condenser, can be kept within the permissible range by way of controlling the heat pump and an additional air-to-air heat exchanger in the process air channel.

Alongside an evaporator, condenser and compressor, the heat pump in the condensation dryer according to the invention has a relief valve or throttle valve in the flow direction of the cryogen between the condenser and evaporator. A permanently set throttle or capillary can also be used instead of a valve of said type.

The inventive dryer includes an air-to-air heat exchanger located preferably in the process air channel. The air-to-air heat exchanger can be used only for additionally cooling the moisture-laden air and condensing the moisture it contains. The heat in the process air from the drying chamber is, though, preferably used in the air-to-air heat exchanger for additionally heating the process air. The air-to-air heat exchanger in the process air channel can therein be inventively located—proceeding from a process air inlet in the room where the dryer is installed—for example in front of a heat pump's evaporator, between an evaporator and the blower, or between the blower and heater.

The invention relates also to a method for operating a dryer having a drying chamber, a process air channel in which is located a heater for heating the process air and wherein the heated process air can be ducted into the drying chamber by means of a blower, a motor and a controller, which dryer is set up for operation drawing an electric power that never exceeds a pre-specified value Pₘₐₓ, characterized in that the dryer is operated in such a way as to draw the electric power at least in phases in accordance with the pre-specified value Pₘₐₓ.

The invention has the advantage that a maximum heating power can be used for drying. When a heat pump is used, the power is the sum of the heat pump's and condenser's heating power. Extremely fast drying can thus be achieved notwithstanding a limitation on connected load preset by the power-supply grid.

A preferred exemplary embodiment of the invention is a domestic appliance in the form of a vented dryer having a heat pump of the above-described compressor type and an additional electric heater. The heater serves primarily to quickly heat the dryer's components and the laundry being dried at the start of operation for drying same. It is advantageous even during the heating phase for the electric power draws of the heater and heat pump as well as of the dryer's further active components to have been mutually coordinated and to be controlled by the dryer's controller in such a way that the dryer will, overall, draw an electric power corresponding to the pre-specified maximum value Pₘₐₓ. Heating in a particularly short time will be enabled thereby.

It should be possible, in a quasi-stationary phase of operation directly following heating, for the heat pump to be operating on its own in order to ensure drying in the most energy-saving manner possible. In any event, however, the heater can also be operated in the quasi-stationary phase when particularly fast drying is desired, with the power draw having been dimensioned and being controlled such that, overall, the dryer will again draw an electric power corresponding to the pre-specified maximum value Pₘₐₓ. A maximum possible heating power will thereby be supplied to the drying process and thus, at the possible expense of a certain disadvantage in energy consumption, an as short as possible drying process achieved. Let it be noted that maximizing the heating power in the drying process does not necessarily have to entail raising the temperatures in the drying process. The throughput of air through the dryer can be increased by suitably designing and, so far as is necessary, controlling the blower, and the increased input of heat into the air compensated thereby. So no reduction in the quality of the drying process is associated with its acceleration.

In addition to given possibilities for realizing energy-saving drying, the invention offers a way to provide particularly fast drying, with the features of energy-saving drying being combined particularly advantageously with the features of particularly fast drying.

1. A dryer comprising:
a drying chamber;
a process air channel;
a heater located in the process air channel for heating a process air;
a blower that ducts the heated process air into the drying chamber;
a motor; and
means for the dryer to draw electric power in phases in accordance with a pre-specified value Pₘₐₓ while operating, wherein the dryer draws an electric power that never exceeds the pre-specified value Pₘₐₓ.

2. The dryer of claim 1, wherein the means comprises a controller.

3. The dryer of claim 1, wherein the means for the dryer to draw electric power at least in phases in accordance with a pre-specified value Pₘₐₓ while operating achieves the pre-specified value Pₘₐₓ by setting a drawn power P_{H} of the heater.

4. The dryer of claim 3, wherein the heater has two switchable heating stages.

5. The dryer of claim 4, wherein the heater comprises a two-stage heater having a first switchable heating stage in a first electric circuit and a second switchable heating stage in a second electric circuit parallel to the first switchable heating stage.

6. The dryer of claim 3, wherein the heater comprises means for continuously setting the heater's power output P_{H}.

7. The dryer of claim 1, further comprising a heat pump circuit having an evaporator, a condenser and a compressor.

8. The dryer of claim 1, wherein the dryer comprises a circulating-air dryer.

9. The dryer of claim 1, wherein the dryer comprises a vented dryer.

10. The dryer of claim 1, further comprising an air-to-air heat exchanger in the process air channel.

11. A method for operating a dryer having a drying chamber, the method comprising:
heating a process air with a heater in a process air channel; and
ducting the heated process air into the drying chamber with a blower, wherein operation of the dryer draws an electric power in phases that never exceeds a pre-specified value Pₘₐₓ during operation of the dryer.
